(19) United States
(12) Patent Application Publication
(10) Pub. No.: US 2007/0080509 A1
(43) Pub. Date: Apr. 12, 2007

(54) Control lever structure of active geometry control suspension for vehicles

(76) Inventor: Jung-Won Kim, Bucheon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,079

(22) Filed: Dec. 12, 2005

(30) Foreign Application Priority Data
Oct. 6, 2005 (KR) 10-2005-0093765

(51) Int. Cl. B60G 7/00; B60G 7/02; B60G 17/016

(52) U.S. Cl. 280/5.52; 280/5.522; 280/86.758; 280/93.51

(57) ABSTRACT

A control lever structure of an active geometry control suspension. The control lever structure has firm supporting force to withstand loads acting in perpendicular and axial directions of a rotating shaft of a control lever, thus allowing the control lever to be reliably mounted and held to a vehicle body.

### CROSS-REFERENCE TO RELATED APPLICATIONS

The present application is based on, and claims priority from, Korean Application Serial Number 10-2005-0093765, filed on Oct. 6, 2005, the disclosure of which is hereby incorporated by reference herein in its entirety.

### FIELD OF THE INVENTION

The present invention relates, in general, to a control lever structure of an active geometry control suspension for vehicles and, more particularly, to the structure of a rotating shaft of a control lever.

### BACKGROUND OF THE INVENTION

An active geometry control suspension is constructed so that when a controller executing a control operation according to operating parameter, such as speed and steering angle, operates an actuator mounted to a vehicle body, the motion of the actuator is transmitted to a knuckle to rotate the knuckle, thus actively controlling the toe-in of wheels.

A mechanism for transmitting the motion of the actuator to the knuckle is operated so that a control lever rotated by the linear motion of an actuating rod of the actuator rectilinearly moves an assist link which is connected between the knuckel and the control lever. The control lever is secured to the vehicle body via a rotating shaft such that it is rotated by the linear motion of the actuator. The controler lever is integrally provided with a lever arm which is hinged to an assist arm to rectilinearly move the assist arm.

The rotating shaft of the control lever is not parallel to the lever arm. As such, because the rotating shaft of the control lever is not parallel to the lever arm, a large load is applied to the rotating shaft of the control lever in an axial direction as well as in a direction perpendicular to the rotating shaft, due to manipulating force applied by the actuator and a load input from wheels during the driving of a vehicle.

### SUMMARY OF THE INVENTION

Embodiments of the present invention provide a control lever structure of an active geometry control suspension, which provides stable and firm supporting force withstanding the load that acts on a rotating shaft of a control lever in axial and perpendicular directions of the rotating shaft, thus allowing the control lever to be stably and firmly held to a vehicle body.

A control lever structure of an active geometry control suspension according to an embodiment of the present invention includes a lever housing. A cylindrical inner pipe passes through the lever housing to be inserted into the lever housing. A pillow ball part has a spherical shape and protrudes integrally from a predetermined portion of the inner pipe. A ball seat is inserted into the lever housing to support the pillow ball part. A cylindrical bush surrounds an outer portion of a cylindrical part of the inner pipe, and is inserted into the lever housing.

### BRIEF DESCRIPTION OF THE DRAWINGS

For a better understanding of the nature and objects of the present invention, reference should be made to the following detailed description with the accompanying drawings, in which:

FIG. 1 is a schematic perspective view of a control lever of an active geometry control suspension according to an embodiment of the present invention,

FIG. 2 is an exploded perspective view of the structure of a control lever according to an embodiment of the present invention; and

FIG. 3 is a sectional view taken along line III-III of FIG. 2.

### DETAILED DESCRIPTION OF THE PREFERRED EMBODIMENTS

Hereinafter, the preferred embodiment of the present invention will be described with reference to the accompanying drawings.

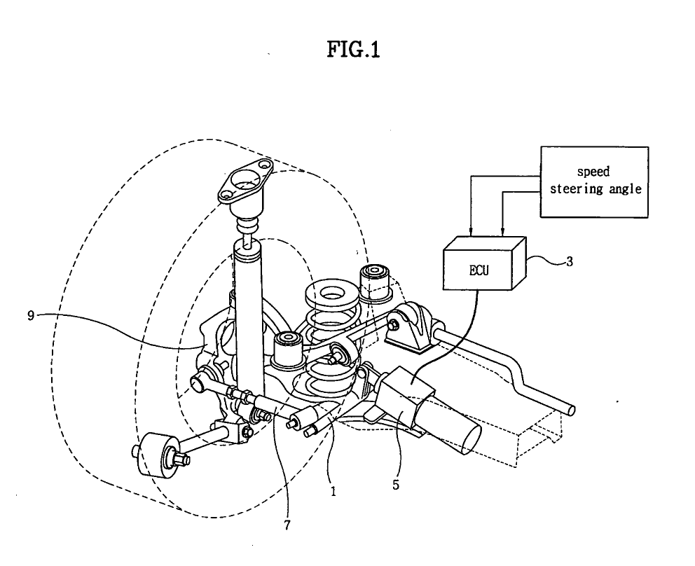

Referring to FIG. 1, the structure of an active geometry control suspension having a control lever I according to the present invention is disclosed.

When a controller 3, performing a control operation according to operating parameters of a vehicle such as speed or steering angle, operates an actuator 5 which is mounted to a vehicle body, the motion of the actuator 5 is transmitted through the control lever 1 and an assist link 7 to a knuckle 9. knuckel 9 is thus rotated and, toe-in of the wheels is thereby actively controlled.

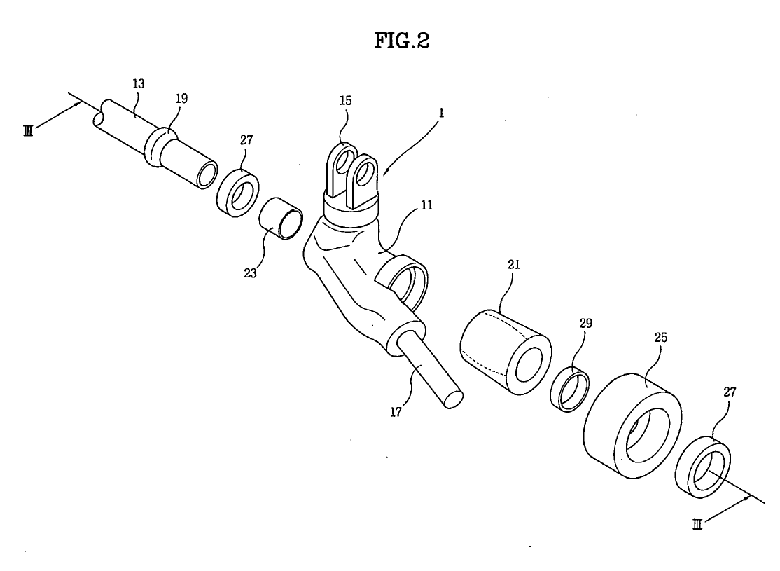

As shown in FIG. 2, the control lever 1 includes a lever housing 11 and an inner pipe 13 control lever 1 is rotatably supported on the vehicle body by inserting a bolt into the inner pipe 13.

The lever housing 11 is provided with a fork 15 so connected to the actuator 5 via the fork 15. The cylindrical inner pipe 13 passes through and is inserted into the lever housing 11. The lever housing 11 is integrally provided with a lever arm 17 having an axis which crosses an axis of the inner pipe 13.

A pillow ball part 19 having a spherical shape integrally protrudes from a predetermined position on the inner pipe 13.

The control lever 1 is provided with a ball seat 21 and a cylindrical bush 23. The ball seat 21 is inserted into the lever housing 11 to support the pillow ball part 19. The bush 23 has a cylindrical shape to surround the outer portion of the cylindrical part of the inner pipe 13, and is inserted into the lever housing 11.

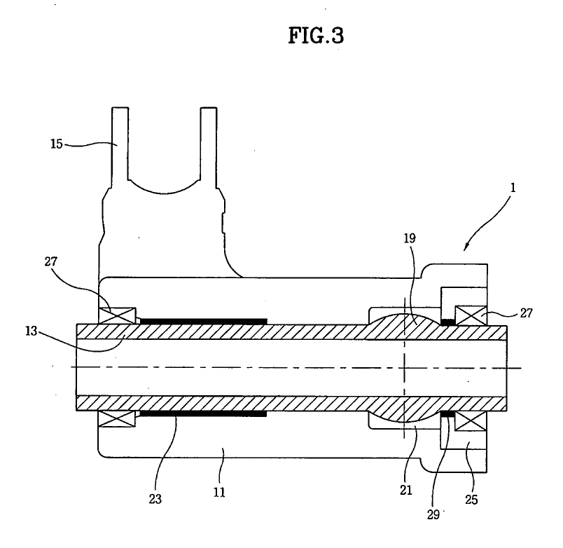

A plug 25 is further provided on the outer portion (the right end of FIG. 3) of the pillow ball part 19 and the ball seat 21, which are positioned in the lever housing 11, and is press-fitted into the lever housing 11. An oil seal 27 is press-fitted between the plug 25 and the inner pipe 13, thus preventing oil from leaking out from the lever housing 11, in addition to preventing external impurities from entering the lever housing 11. The plug 25 functions to secure the ball seat 21 to a predetermined position such that the ball seat 21 is not removed from the lever housing 11.

In one embodiment of the present invention, a smaller cylindrical bush 29 is additionally provided between the inner circumference of the plug 25 and the outer circumference of the inner pipe 13. This arrangement more firmly bears the load that acts in a direction perpendicular to the rotating shaft of the control lever 1 at a position around the pillow ball part 19.

course, another oil seal 27 may be provided on the outer portion (the left end of FIG. 3) of the cylindrical bush 23 which is positioned in the lever housing 11. Bush 23 is press-fitted into the lever housing 11, thus preventing oil from leaking out from the lever housing 11, in addition to preventing external impurities from entering the lever housing 11.

A control lever 1 of an active geometry control suspension, constructed as described above, firmly and stably supports a load acting in a direction of the rotating shaft of the control lever 1, that is, the axial direction of the inner pipe 13, using the pillow ball part 19. Further, the cylindrical bush 23 and the smaller cylindrical bush 29 safely support a load which acts in a direction perpendicular to the rotating shaft of the control lever 1. The pillow ball part 19 also supports some of the load which acts in a direction perpendicular to the rotating shaft of the control lever 1.

Thus, as described above, loads acting in all directions including the direction parallel or perpendicular to the direction of the rotating shaft of the control lever 1 can be safely supported by the pillow ball part 19, the ball seat 21, the cylindrical bush 23, and the smaller cylindrical bush 29. That is, the rotating shaft the lever arm 17 crosses the rotating shaft of the control lever 1, thus firmly withstanding force intended to roll the control lever 1 by acting on the control lever 1, in all directions.

Oil seals 27 or the like efficiently prevent oil for lubricating internal components from leaking to the outside, and prevent external impurities from entering the lever housing, thus allowing the pillow ball part 19, the ball seat 21, the cylindrical bush 23, and the smaller cylindrical bush 29 to withstand a load while being safe and durable.

As apparent from the foregoing, in an active geometry control suspension system safe and firm supporting force is provided to withstand loads acting in perpendicular and axial directions of a rotating shaft of a control lever, thus allowing the control lever to be safely and firmly mounted and held to a vehicle body.

What is claimed is:

1. A control lever structure of an active geometry control suspension, comprising:
a lever housing;
a cylindrical inner pipe passing through the lever housing;
a pillow ball part having a spherical shape and protruding integrally from a predetermined portion of the inner pipe;
a ball seat inserted into the lever housing to support the pillow ball part; and
a cylindrical bush surrounding an outer portion of a cylindrical part of the inner pipe, the cylindrical bush being inserted into the lever housing.

2. The control lever structure as defined in claim 1, further comprising:
a plug, provided on an outer portion of the pillow ball part and the ball seat, which are positioned in the lever housing, and press-fitted into the lever housing; and
an oil seal press-fitted between the plug and the inner pipe.

3. The control lever structure as defined in claim 2, further comprising a smaller cylindrical bush provided between an inner circumference of the plug and an outer circumference of the inner pipe.

4. The control lever structure as defined in claim 2, further comprising an oil seal provided on an outer portion of the cylindrical bush which is positioned in the lever housing, and press-fitted into the lever housing.

5. The control lever structure as defined in claim 1, wherein a lever arm is integrally provided on the lever housing, and has an axis crossing an axis of the inner pipe.
